(19) United States
(12) Patent Application Publication
(10) Pub. No.: US 2016/0277477 A1
(43) Pub. Date: Sep. 22, 2016

(54) INFORMATION PROCESSING APPARATUS, TERMINAL DEVICE, INFORMATION PROCESSING METHOD, AND NON-TRANSITORY COMPUTER READABLE RECORDING MEDIUM

(71) Applicant: YAHOO JAPAN CORPORATION, Tokyo (JP)

(72) Inventors: Yosuke ARAI, Tokyo (JP); Yuki TAKI, Tokyo (JP)

(73) Assignee: YAHOO JAPAN CORPORATION, Tokyo (JP)

(21) Appl. No.: 15/040,830

(22) Filed: Feb. 10, 2016

(30) Foreign Application Priority Data
Mar. 20, 2015 (JP) 2015-057288

(51) Int. Cl. H04L 29/08; G06F 17/30

(52) U.S. Cl. CPC H04L 67/02; G06F 17/30899

(57) ABSTRACT

An information processing apparatus according to the present invention includes an acquiring unit and an associating unit. The acquiring unit acquires, from an application, terminal information, which is used to identify a terminal device, and feature information, which is created on the basis of information that is allocated to the terminal device and that varies in accordance with the time elapsed, and acquires, from a browser, cookie information and the feature information. Furthermore, the associating unit associates both the terminal information acquired by the acquiring unit and the cookie information acquired by the acquiring unit with the feature information acquired by the acquiring unit.

### CROSS-REFERENCE TO RELATED APPLICATION

The present application claims priority to and incorporates by reference the entire contents of Japanese Patent Application No. 2015-057288 filed in Japan on Mar. 20, 2015.

### BACKGROUND OF THE INVENTION

1. Field of the Invention

The present invention relates to an information processing apparatus, a terminal device, an information processing method, and a non-transitory computer readable recording medium.

2. Description of the Related Art

In recent years, smart devices, such as smart phones, tablet terminals, and the like, are becoming widely used. Users who use terminal devices, such as these smart devices or the like, acquire information by using applications, web browsers, or the like, that are installed in the terminal devices. Thus, there is a provided technology that estimates a same terminal device on the basis of the information related to the terminal device that requests information to be acquired. For example, see Patent Document 1: Japanese Patent No. 5580372.

However, the conventional technology described above does not always enable to appropriately estimate the sameness of the terminal device and to appropriately associate pieces of information collected from the same terminal device. For example, even if pieces of information related to the terminal device are similar, the terminal device may possibly be a different terminal device and thus the pieces of information collected from the same terminal device are not always appropriately associated.

### SUMMARY OF THE INVENTION

It is an object of the present invention to at least partially solve the problems in the conventional technology.

According to one aspect of an embodiment, an information processing apparatus includes an acquiring unit that acquires, from an application, terminal information, which is used to identify a terminal device, and feature information, which is created on the basis of information that is allocated to the terminal device and that varies in accordance with the time elapsed, and that acquires, from a browser, cookie information and the feature information, and an associating unit that associates both the terminal information acquired by the acquiring unit and the cookie information acquired by the acquiring unit with the feature information acquired by the acquiring unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating an example of an association process according to an embodiment;

FIG. 2 is a schematic diagram illustrating a configuration example of a server device according to the embodiment;

FIG. 3 is a schematic diagram illustrating an example of an association information storing unit according to the embodiment;

FIG. 4 is a schematic diagram illustrating an example of a cookie information storing unit according to the embodiment;

FIG. 5 is a schematic diagram illustrating a configuration example of a terminal device according to the embodiment;

FIG. 6 is a schematic diagram illustrating an example of a terminal ID storing unit according to the embodiment;

FIG. 7 is a schematic diagram illustrating an example of a discrimination information storing unit according to the embodiment;

FIG. 8 is a schematic diagram illustrating an example of a cookie information storing unit according to the embodiment;

FIG. 9 is a sequence diagram illustrating the flow of an association process according to the embodiment;

FIG. 10 is a schematic diagram illustrating an example of an association process according to a first modification;

FIG. 11 is a schematic diagram illustrating an example of an association process according to a second modification;

FIG. 12 is a schematic diagram illustrating a configuration example of a server device according to the second modification;

FIG. 13 is a sequence diagram illustrating the flow of an association process according to the second modification; and

FIG. 14 is a block diagram illustrating an example of the hardware configuration of a computer that implements the function performed by an information processing apparatus.

### DETAILED DESCRIPTION OF THE PREFERRED EMBODIMENTS

A mode (hereinafter, referred to as an “embodiment”) for implementing an information processing apparatus, a terminal device, an information processing method, and an information processing program according to the present invention will be described in detail below with reference to the drawings. Furthermore, note that the information processing apparatus, the terminal device, the information processing method, and the information processing program according to the present invention are not limited to the embodiment. Furthermore, note that, in the embodiments described below, the same components are denoted by the same reference signs and an overlapping description will be omitted.

1. Association Process

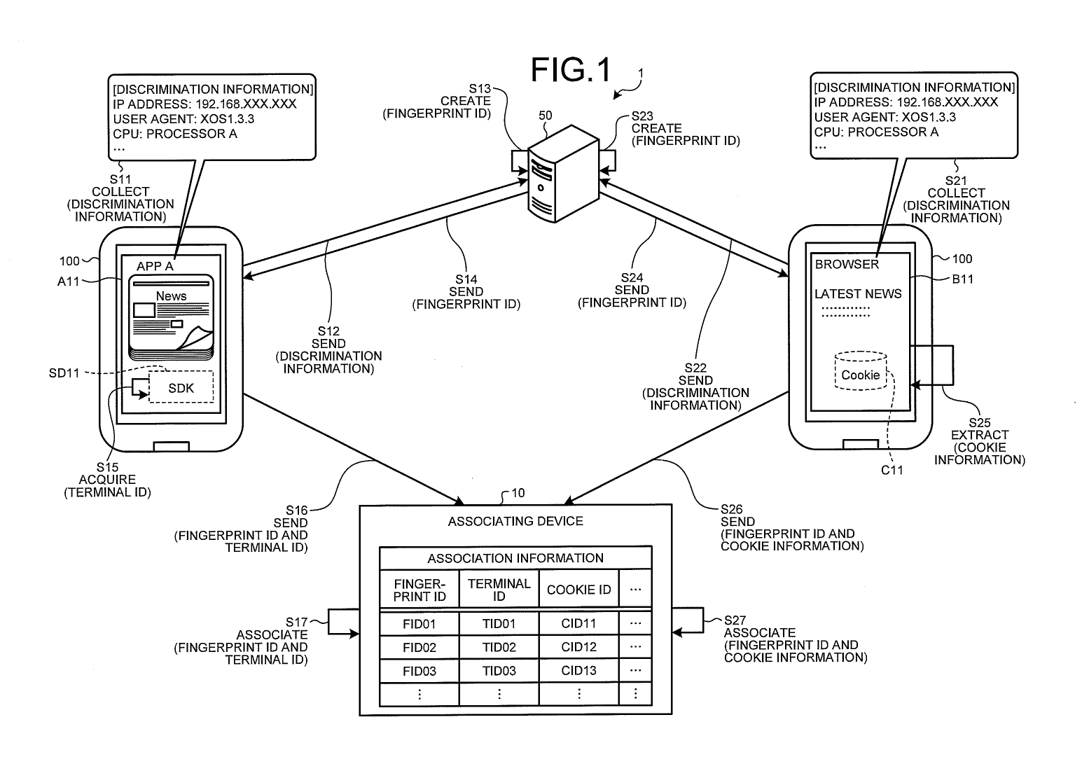

First, an example of an association process according to an embodiment will be described with reference to FIG. 1. FIG. 1 is a schematic diagram illustrating an example of an association process according to an embodiment. Specifically, FIG. 1 is a schematic diagram illustrating an example of the association process performed when a terminal device sends the terminal information that is acquired by an application (hereinafter, sometimes referred to as an “app”) and feature information and the terminal device sends cookie information on a browser and the feature information.

As illustrated in FIG. 1, an association system 1 includes therein terminal devices 100, an ID issuing server 50, and an associating device 10. The terminal devices 100, the ID issuing server 50, and the associating device 10 are connected via a predetermined communication network, which is not illustrated, such that the terminal devices 100 and the associating device 10 can be communicated each other in a wired or a wireless manner. Furthermore, in the association system 1 illustrated in FIG. 1, a plurality of the terminal devices 100, a plurality of the ID issuing servers 50, and a plurality of the associating devices 10 may also be included.

The terminal device 100 is a terminal device that is used by a user. In accordance with an operation performed by a user, the terminal device 100 starts up, an app or a browser installed in the terminal device 100 and performs various kinds of processes. The terminal device 100 collects discrimination information including information that is allocated to the terminal device 100 and that varies in accordance with time elapsed. Then, the terminal device 100 sends the collected discrimination information to the ID issuing server 50 that creates feature information on the basis of the discrimination information. The discrimination information in detail will be described later.

Furthermore, the terminal device 100 sends, to the associating device 10, both the terminal ID that is the terminal information for identifying the terminal device 100 and that is acquired by an app and the feature information that is acquired from the ID issuing server 50. Furthermore, the terminal device 100 sends, to the associating device 10, both the cookie information in a browser and the feature information that is acquired from the ID issuing server 50. In a description below, the terminal device 100 is sometimes referred to as a user. Namely, in a description below, the terminal device 100 can be read as a user. In the embodiment, a description will be given of a case in which a smart phone is used as the terminal device 100. Furthermore, the terminal device 100 described above is not limited to a smart phone, but may also be, for example, a tablet type terminal, a notebook personal computer (PC), a desktop PC, a mobile phone device, a personal digital assistant (PDA), or the like.

The ID issuing server 50 creates a fingerprint ID that is the feature information on the basis of the discrimination information that was acquired from the terminal device 100. Then, the ID issuing server 50 sends the created fingerprint ID to the terminal device 100.

The associating device 10 is an information processing apparatus that associates the terminal ID acquired from the terminal device 100 with the fingerprint ID. Furthermore, the associating device 10 may also provide the association information to an external information processing apparatus, such as an advertisement distribution device. Furthermore, the associating device 10 may also be an advertisement distribution device that performs advertisement distribution on the basis of the association information.

In the following, the association process performed when the terminal device 100 sends both the terminal ID that is acquired by an app and the fingerprint ID and then the terminal device 100 sends the cookie information in a browser and the fingerprint ID will be described with reference to FIG. 1. In the terminal device 100 illustrated in FIG. 1, an app A (hereinafter, referred to as an “app A11”) has been started up and an app A11 is displayed on the terminal device 100. At this point, a predetermined software development kit (SDK) is included in the app A11 that is installed in the terminal device 100. Hereinafter, the SDK included in the app A11 is referred to as a development kit SD11. Here, the development kit SD11 in the app A11 can acquire the terminal information that is used to identify the terminal device 100 from a storing unit 120 (a terminal ID storing unit 121) in the terminal device 100. Furthermore, the storing unit 120 and the terminal ID storing unit 121 will be described in detail later.

As illustrated in FIG. 1, the app A11 in the terminal device 100 collects discrimination information at a predetermined timing (Step S11). For example, the app A11 may also collect the discrimination information at the predetermined intervals (for example, at the intervals of 10 minutes) at a timing at which the app A11 is started up or during a time period for which the app A11 is being started up. In the example illustrated in FIG. 1, the app A11 collects, as the discrimination information, the information that is related to an IP address (Internet Protocol) allocated to the terminal device 100 at the time of collection performed at Step S11, the information that is related to a user agent of the terminal device 100, and the information that is related to a central processing unit (CPU) of the terminal device 100. Specifically, the app A11 collects, as the discrimination information, the information of the IP address “192.168.XXX.XXX”, the user agent “XOS1.3.3”, the CPU “processor A”, and the like. Here, the IP address is the information that discriminates the terminal device 100 to which the subject IP address is allocated and that varies in accordance with the location of the terminal device 100, the time, or the like. Namely, in the discrimination information collected by the app A11, the discrimination information including the information that is allocated to the terminal device 100 and that varies in accordance with the time elapsed is included. Furthermore, the user agent is the system information on the terminal device 100 and means the software or the hardware that is used when the terminal device 100 uses data on the basis of a predetermined protocol. In the user agent, various kinds of information, such as an operating system (OS) name, the version of the OS, a browser name, the version of the browser, a language; however, in the embodiment, only an OS and the version of the OS represent the user agent. Furthermore, the CPU is the system information on the terminal device 100 and indicates the CPU mounted on the terminal device 100. Furthermore, in the discrimination information, the terminal information that is used to identify the terminal device 100 may also be included.

Thereafter, the app A11 sends the discrimination information collected at Step S11 to the ID issuing server 50 (Step S12). For example, if the app A11 has completed the collection of the discrimination information at Step S11, the app A11 immediately sends the collected discrimination information to the ID issuing server 50.

The ID issuing server 50 that has received the discrimination information creates a fingerprint ID on the basis of the received discrimination information (Step S13). Furthermore, the fingerprint ID is the information that is allocated to the terminal device 100 and that is created on the basis of the discrimination information that includes the information that varies in accordance with the time elapsed; however, a description thereof in detail will be described later. After the ID issuing server 50 creates the fingerprint ID, the ID issuing server 50 sends the created fingerprint ID to the terminal device 100 (Step S14).

After having acquired the fingerprint ID, the app A11 acquires the terminal ID from the terminal ID storing unit 121 in the terminal device 100 (Step S15). Furthermore, the app A11 may also acquire the terminal ID before the app A11 receives the fingerprint ID. Then, the app A11 sends, to the associating device 10 together with the terminal ID acquired at Step S15, the fingerprint ID acquired from the ID issuing server 50 (Step S16).

The associating device 10 that has received the terminal ID and the fingerprint ID from the terminal device 100 associates the terminal ID with the fingerprint ID (Step S17). Consequently, the associating device 10 performs the association between the terminal ID and the fingerprint ID. Furthermore, if the received fingerprint ID has already been associated with the cookie information and registered, the associating device 10 associates the received terminal ID with the registered fingerprint ID. Consequently, the associating device 10 can perform the association between the cookie information and the terminal ID.

In the terminal device 100 illustrated on the right side in FIG. 1, a browser has been started up and a browser B11 is displayed on the terminal device 100. Furthermore, the terminal device 100 illustrated on the right side in FIG. 1 performs the process at Step S21 and the subsequent processes after a predetermined elapsed of time since the process at Step S17 has been performed.

As illustrated in FIG. 1, the browser B11 in the terminal device 100 collects the discrimination information at the predetermined timing (Step S21). For example, the browser B11 may also collect the discrimination information at the timing at which the browser B11 is started up, during the time period for which the browser B11 is being started up, or at the predetermined intervals (for example, at the intervals of 10 minutes). In the example illustrated in FIG. 1, the browser B11 collects, as the discrimination information, the information that is related to the IP address allocated to the terminal device 100 at the time of collection performed at Step S21, the information that is related to the user agent of the terminal device 100, and the information that is related to the CPU of the terminal device 100. Specifically, the browser B11 collects, as the discrimination information, information on the IP address “192.168.XXX.XXX”, the user agent “XOS1.3.3”, the CPU “processor A”, or the like. Here, the IP address is the information that discriminates the terminal device 100 to which the subject IP address is allocated and that varies in accordance with the location of the terminal device 100, the time, or the like. Namely, in the discrimination information collected by the browser B11, the discrimination information including the information that is allocated to the terminal device 100 and that varies in accordance with the time elapsed is included.

Thereafter, the browser B11 sends the discrimination information collected at Step S21 to the ID issuing server 50 (Step S22). For example, if the browser B11 completes the collection of the discrimination information at Step S21, the browser B11 immediately sends the collected discrimination information to the ID issuing server 50.

The ID issuing server 50 that has received the discrimination information creates a fingerprint ID on the basis of the received discrimination information (Step S23). For example, the fingerprint ID is the information that is allocated to the terminal device 100 and that is created on the basis of the discrimination information that includes therein the information that varies in accordance with the time elapsed. After having created the fingerprint ID, the ID issuing server 50 sends the created fingerprint ID to the terminal device 100 (Step S24).

After having acquired the fingerprint ID, the browser B11 extracts, from the cookie C11, the cookie information that is related to the server that is associated with a predetermined domain name (Step S25). For example, the browser B11 may also extracts, from the cookie C11, the cookie information that is related to the server that is associated with the domain name of a Web page that is displayed at the time of extraction performed at Step S25. Furthermore, the browser B11 may also extract the cookie information before the browser B11 receives the fingerprint ID. Thereafter, the browser B11 sends, to the associating device 10 together with the cookie information extracted at Step S25, the fingerprint ID that is acquired from the ID issuing server 50 (Step S26).

The associating device 10 that has received both the cookie information and the fingerprint ID from the terminal device 100 associates the cookie information with the fingerprint ID (Step S27). Consequently, the associating device 10 performs the association between the cookie information and the fingerprint ID. Furthermore, if the received fingerprint ID has already been associated with the terminal ID and registered, the associating device 10 associates the received cookie information with the registered fingerprint ID. Consequently, the associating device 10 can perform the association between the cookie information and the terminal ID. Furthermore, the processes at Steps S21 to S27 may also be performed before the processes at Steps S11 to S17.

As described above, in the association system 1 according to the embodiment, when the associating device 10 receives the cookie information and the fingerprint ID from the terminal device 100, the associating device 10 associates the cookie information with the fingerprint ID. Furthermore, in the association system 1, when the associating device 10 receives the terminal ID and the fingerprint ID from the terminal device 100, the associating device 10 associates the terminal ID with the fingerprint ID. Namely, even if each of the terminal ID and the cookie information is acquired at a different timing, the associating device 10 can estimate, on the basis of the fingerprint ID, that the terminal ID and the cookie information are the information acquired from the same terminal device 100. Consequently, the terminal device 100 can appropriately associate the information collected from the same terminal device 100.

Furthermore, the associating device 10 registers, as the association information, the cookie information, the terminal ID, and the fingerprint ID received from the terminal device 100. For example, if the terminal ID included in the received association information has already been registered, the associating device 10 registers the cookie information, which is included in the received association information, as the cookie information that is associated with the registered terminal ID. Consequently, the associating device 10 can perform the association between the terminal ID and the cookie information. For example, the associating device 10 provides the association information to an external information processing apparatus, such as an advertisement distribution device that is included in the association system 1. Consequently, the association system 1 can perform an appropriate advertisement distribution with respect to a user. Thus, the association system 1 can increase the advertising effectiveness. Furthermore, the associating device 10 may also be an advertisement distribution device that performs the advertisement distribution on the basis of the association information. Consequently, the association system 1 can perform an appropriate advertisement distribution with respect to a user. Thus, the association system 1 can increase the advertising effectiveness.

2. Configuration of the Server Device

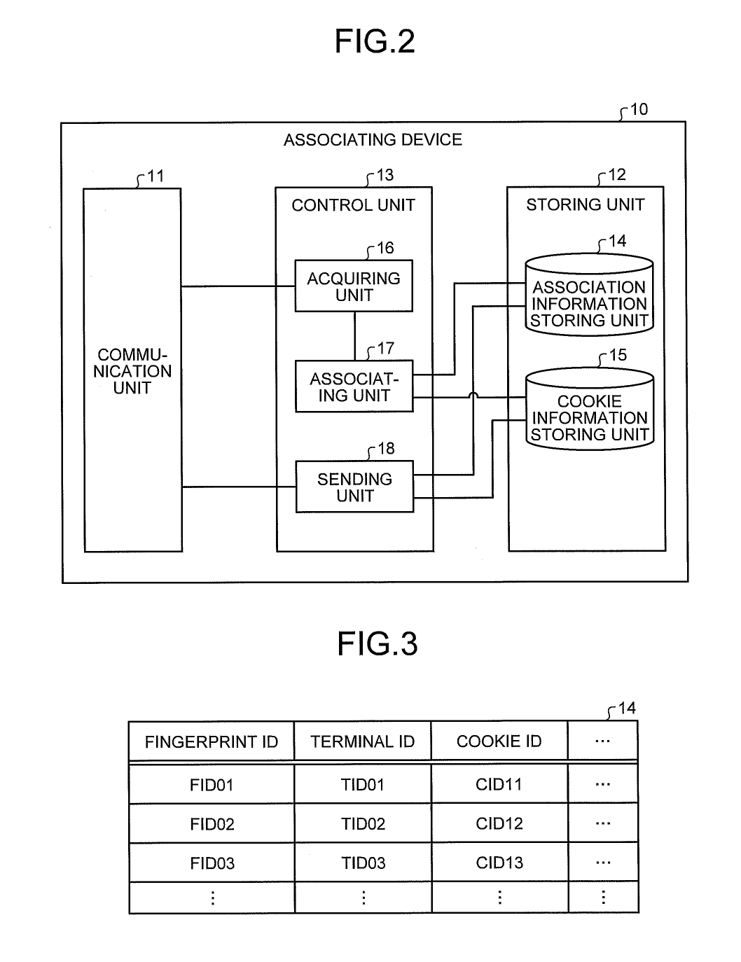

In the following, the configuration of the associating device 10 according to the embodiment will be described with reference to FIG. 2. FIG. 2 is a schematic diagram illustrating a configuration example of a server device according to the embodiment. As illustrated in FIG. 2, the associating device 10 includes a communication unit 11, a storing unit 12, and a control unit 13. Furthermore, the associating device 10 may also include an input unit (for example, a keyboard, a mouse, etc.) that receives various kinds of operations from an administrator or the like of the associating device 10 and a displaying unit (for example, a liquid crystal display, etc.) on which various kinds of information is displayed.

The communication unit 11 is implemented by, for example, a NIC or the like. Furthermore, the communication unit 11 is connected to a network in a wired or a wireless manner and sends and receives information to and from the terminal device 100.

The Storing Unit 12

The storing unit 12 is implemented by a semiconductor memory device, such as a RAM, a flash memory, or the like, or implemented by a storage device, such as a hard disk, an optical disk, or the like. The storing unit 12 according to the embodiment includes, as illustrated in FIG. 2, an association information storing unit 14 and a cookie information storing unit 15.

The Association Information Storing Unit 14

The association information storing unit 14 according to the embodiment stores therein the association information. For example, the association information storing unit 14 stores therein the association information received from the terminal device 100. FIG. 3 is a schematic diagram illustrating an example of an association information storing unit according to the embodiment. The association information storing unit 14 illustrated in FIG. 3 has the items, such as the “fingerprint ID”, the “terminal ID”, and the “cookie ID”.

The “fingerprint ID” is information allocated to the terminal device 100 and indicates the feature information that is created on the basis of the discrimination information that includes therein the information that varies in accordance with the time elapsed. The “terminal ID” indicates the feature information that is used to identify the terminal device 100. Furthermore, the “cookie ID” indicates the feature information that is used to identify the cookie information. In the example illustrated in FIG. 3, for the fingerprint ID “FID01”, the terminal ID “TID01” and the cookie ID “CID11” are associated and stored; for the fingerprint ID “FID02”, the terminal ID “TID02” and the cookie ID “CID12” are associated and stored; and, for the fingerprint ID “FID03”, the terminal ID “TID03” and the cookie ID “CID13” are associated and stored.

The Cookie Information Storing Unit 15

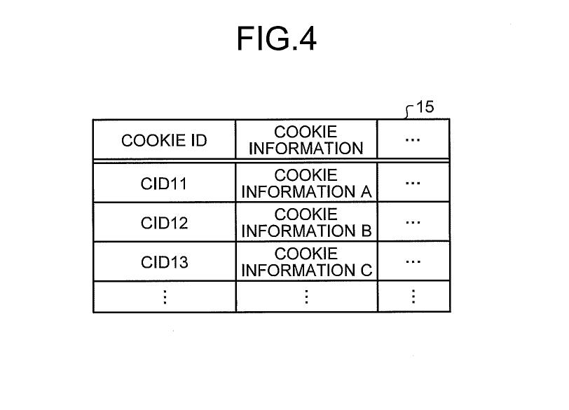

The cookie information storing unit 15 according to the embodiment stores therein the cookie information. For example, the cookie information storing unit 15 associates the cookie information that is included in the association information and that is received from the terminal device 100 with the cookie ID and then stores the associated cookie information and the cookie ID. FIG. 4 is a schematic diagram illustrating an example of a cookie information storing unit according to the embodiment. The cookie information storing unit 15 illustrated in FIG. 4 has the items, such as the “cookie ID”, the “cookie information”, and the like.

The “cookie ID” indicates the feature information that is used to identify the cookie information. The “cookie information” indicates the cookie information. In the example illustrated in FIG. 4, the cookie information A is associated with the cookie ID “CID11” and is stored, the cookie information B is associated with the cookie ID “CID12” and is stored, the cookie information C is associated with the cookie ID “CID13” and is stored. The examples illustrated in FIGS. 3 and 4 indicate that, for example, the cookie information A that is identified by the terminal ID “TID01” and the cookie ID “CID11” is received from the terminal device 100 as the association information. Furthermore, the “cookie information” may also be a file path that indicates an area in which the associated cookie information is stored.

The Control Unit 13

A description will be given here by referring back to FIG. 2. The control unit 13 is implemented by, for example, the CPU, the MPU, or the like executing various kinds of programs (corresponding to an example of an information processing program), which are stored in the storage device in the associating device 10, by using a RAM as a work area. Furthermore, the control unit 13 is implemented by, for example, an integrated circuit, such as an ASIC, an FPGA, or the like.

As illustrated in FIG. 2, the control unit 13 includes an acquiring unit 16, an associating unit 17, and a sending unit 18 and implements or executes the function and the operation of the information processing described below. Furthermore, the internal configuration of the control unit 13 is not limited to the configuration illustrated in FIG. 2 and may also be another configuration as long as the configuration in which the information processing, which will be described later, is performed is used. Furthermore, the connection relation between the processing units included in the control unit 13 is not limited to the connection relation illustrated in FIG. 2 and may also be another connection relation.

The acquiring unit 16 receives the terminal ID and the fingerprint ID from the terminal device 100. Furthermore, the acquiring unit 16 receives the cookie information and the fingerprint ID from the terminal device 100.

The associating unit 17 associates the terminal ID with the fingerprint ID, which are acquired from the acquiring unit 16. Specifically, the associating unit 17 stores, as association information in the association information storing unit 14, the terminal ID and the fingerprint ID that are acquired by the acquiring unit 16. Furthermore, the associating unit 17 associates the cookie information with the fingerprint ID acquired by the acquiring unit 16. Specifically, the associating unit 17 stores cookie information and the fingerprint ID, which are acquired by the acquiring unit 16, as the association information in the association information storing unit 14 and the cookie information storing unit 15. For example, if the fingerprint ID acquired by the acquiring unit 16 has already been associated with the cookie information and registered, the associating unit 17 associates the received terminal ID with the registered fingerprint ID. Furthermore, if the fingerprint ID acquired by the acquiring unit 16 has already been associated with the terminal ID and registered, the associating unit 17 associates the received cookie information with the registered fingerprint ID.

The sending unit 18 sends various kinds of information to an external information processing apparatus. For example, the sending unit 18 sends the association information to the advertisement distribution device. Furthermore, for example, the sending unit 18 may also send information that instructs the terminal device 100 to send the association information. Furthermore, if the associating device 10 is an advertisement distribution device, the sending unit 18 may also distribute an advertisement on the basis of the association information to the terminal device 100.

3. Configuration of the Terminal Device

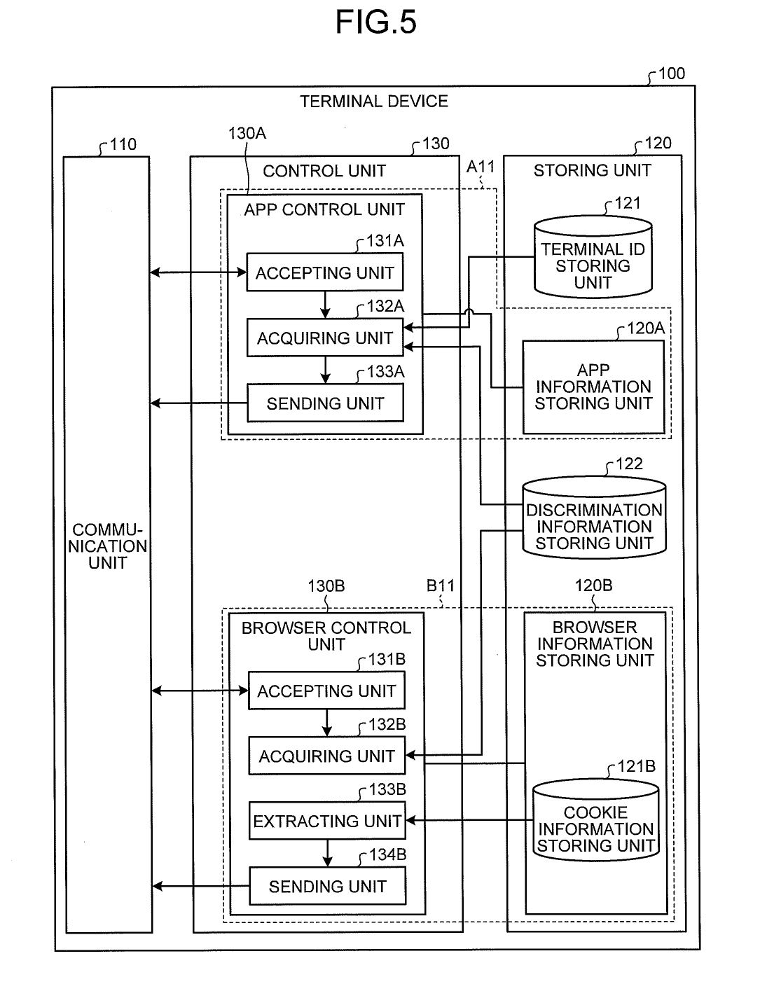

In the following, the configuration of the terminal device 100 according to the embodiment will be described with reference to FIG. 5. FIG. 5 is a schematic diagram illustrating a configuration example of a terminal device according to the embodiment. As illustrated in FIG. 5, the terminal device 100 includes a communication unit 110, the storing unit 120, and a control unit 130. Furthermore, although not illustrated in the drawing, the terminal device 100 includes an input unit that receives various kinds of operations from a user and an output unit that is used to output various kinds of information. If, for example, the terminal device 100 includes a function of the touch panel, the input unit receives various kinds operations from a user via a display screen in the terminal device 100. Furthermore, the output unit includes a display screen that is used for the terminal device 100 and that is implemented by, for example, a liquid crystal display, an organic Electro-Luminescence (EL) display, or the like and displays various kinds of information.

The Communication Unit 110

The communication unit 110 is implemented by, for example, a communication circuit or the like. Furthermore, the communication unit 110 is connected to a predetermined communication network (not illustrated) in a wired or a wireless manner and sends and receives information to and from the associating device 10 or the ID issuing server 50.

The Storing Unit 120

The storing unit 120 is implemented by, for example, a semiconductor memory device, such as a random access memory (RAM), a flash memory, and the like, or a storage device, such as a hard disk, an optical disk, and the like. The storing unit 120 stores, in the terminal device 100, information related to, for example, the OS, such as programs or the like. The storing unit 120 according to the embodiment includes, as illustrated in FIG. 5, the terminal ID storing unit 121, a discrimination information storing unit 122, an app information storing unit 120A, a browser information storing unit 120B.

The Terminal ID Storing Unit 121

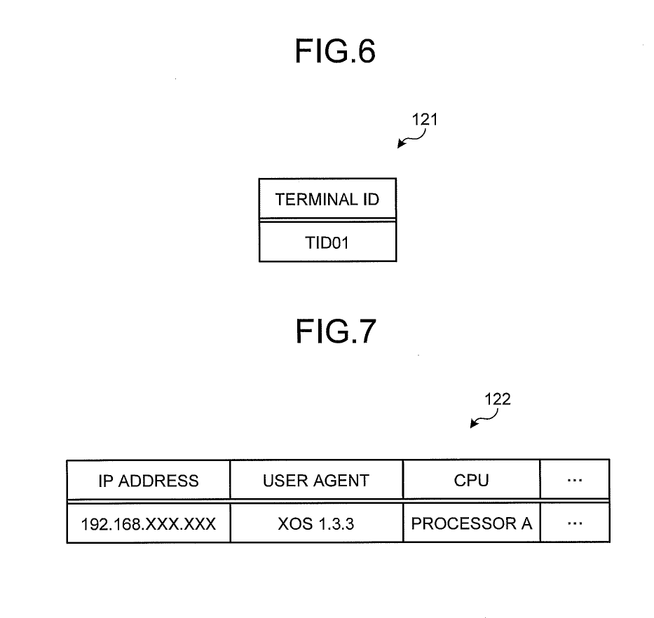

The terminal ID storing unit 121 according to the embodiment stores therein the terminal information that is used to identify the terminal device 100. FIG. 6 is a schematic diagram illustrating an example of a terminal ID storing unit according to the embodiment. The terminal ID storing unit 121 illustrated in FIG. 6 has the item of the “terminal ID”.

The “terminal ID” indicates the feature information that is used to identify the terminal device 100. In the example illustrated in FIG. 3, “TID01” is stored as the terminal ID.

The Discrimination Information Storing Unit 122

The discrimination information storing unit 122 according to the embodiment stores therein various kinds of information related to the terminal device 100. Specifically, the discrimination information storing unit 122 stores therein the discrimination information that includes therein the information that is allocated to the terminal device 100 and that varies in accordance with the time elapsed. FIG. 7 is a schematic information diagram illustrating an example of a discrimination information storing unit according to the embodiment. The discrimination information storing unit 122 illustrated in FIG. 3 has the items, such as the “IP address”, the “user agent”, the “CPU”, and the like.

The IP address” indicates the information related to the IP address allocated to the terminal device 100. In the example illustrated in FIG. 7, “192.168.XXX.XXX” is stored as the IP address allocated to the terminal device 100. As illustrated in, the IP address is the information that discriminates the terminal device 100 to which the subject IP address is allocated and that varies in accordance with the location of the terminal device 100, the time, or the like. Namely, the information stored in the “IP address” varies in accordance with the time.

Furthermore, the “user agent” indicates the information related to the software or the hardware that is used when the terminal device 100 uses data on the basis of a predetermined protocol. In the example illustrated in FIG. 7, “XOS 1.3.3” is stored as the user agent of the terminal device 100. As described above, in the user agent, various kinds of information, such as the operating system (OS) name, the version of the OS, the browser name, the version of the browser, a language, and the like. Furthermore, the user agent is the information that varies in accordance with an update of the OS or the browser or in accordance with a change in the OS, a browser, a language, or the like. Furthermore, the user agent is the information that is allocated to the terminal device 100 and that varies in accordance with the time elapsed. Furthermore, the “CPU” indicates the CPU mounted on the terminal device 100. In the example illustrated in FIG. 7, the “processor A” is stored as the CPU. Furthermore, the discrimination information storing unit 122 is not limited to the unit described above and may also store various kinds of information in accordance with purposes as long as the information is related to the terminal device 100. Furthermore, in the embodiment, for an explanation, the configuration in which the discrimination information is stored in the discrimination information storing unit 122 is used as an example; however, the discrimination information may also be stored in each of an associated area in the storing unit 120.

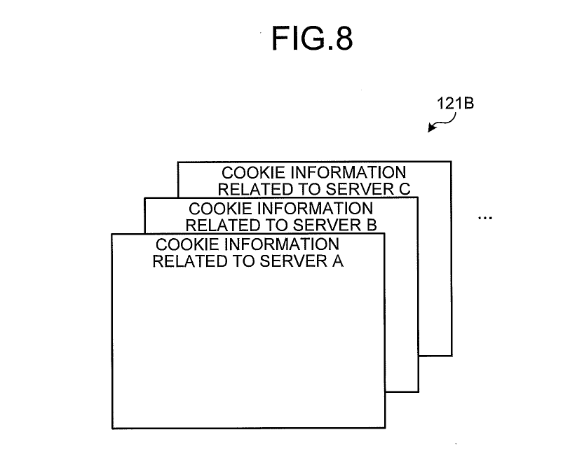

Furthermore, the app information storing unit 120A stores therein the information, for example, programs or the like related to the application installed in the terminal device 100. Furthermore, the browser information storing unit 120B stores therein information, for example, programs or the like related to the browser installed in the terminal device 100. The browser information storing unit 120B includes a cookie information storing unit 121B. As illustrated in FIG. 8, the cookie information storing unit 121B stores therein, for each server, the information related to the cookie in the browser. In the example illustrated in FIG. 8, the cookie information storing unit 121B stores therein, for each associated server (domain), the cookie information, such as the cookie information related to the server A, the cookie information related to the server B, the cookie information related to the server C, and the like.

The Control Unit 130

A description will be given here by referring back to FIG. 5. The control unit 130 is implemented by, for example, the CPU, the MPU, or the like executing various kinds of programs (corresponding to an example of an information processing program), which are stored in the storage device in the storing unit 120 or the like in the terminal device 100, by using a RAM as a work area. For example, installed application programs are included in the various kinds of programs. Furthermore, the control unit 130 is implemented by an integrated circuit, such as an ASIC, an FPGA, of the like.

As illustrated in FIG. 5, the control unit 130 includes an app control unit 130A and a browser control unit 130B. Furthermore, the internal configuration of the control unit 130 is not limited to the configuration illustrated in FIG. 5 and includes another configuration for implementing the function performed by the terminal device 100 as a smart phone.

The App Control Unit 130A

First, the app control unit 130A will be described. The app control unit 130A is a control unit associated with the app A11 and performs a process, such as an association process by using the development kit SD11 in the app A11, and performs various kinds of processes of the app A11. In the example illustrated in FIG. 5, it is assumed that the app control unit 130A and the app information storing unit 120A are associated with the app A11 and it is assumed that, for the other areas in the storing unit 120, an access is possible only in the area that is connected by a connecting cable.

The app control unit 130A includes, as particularly and closely related to the present invention, an accepting unit 131A, an acquiring unit 132A, and a sending unit 133A and implements or executes the function and the operation of the association process that will be described below. Furthermore, the internal configuration of the app control unit 130A is not limited to the configuration illustrated in FIG. 5 but may also be another configuration as long as the configuration in which the association process, which will be described later, is performed is used. Furthermore, the internal configuration of the app control unit 130A is not limited to the configuration illustrated in FIG. 5 but includes another configuration that is used to implement various kinds of processes performed by the app A11.

The accepting unit 131A accepts an instruction and information related to the application. For example, the accepting unit 131A accepts various kinds of operations from a user via an input unit. Furthermore, the accepting unit 131A accepts the information related to an update of an application or the like via the communication unit 110.

If the acquiring unit 132A sends the discrimination information to the ID issuing server 50, the acquiring unit 132A acquires the discrimination information from the discrimination information storing unit 122. Furthermore, when the acquiring unit 132A sends the terminal ID to the associating device 10, the acquiring unit 132A acquires the terminal ID from the terminal ID storing unit 121.

The sending unit 133A sends the discrimination information acquired by the acquiring unit 132A to the ID issuing server 50. Furthermore, the sending unit 133A sends the terminal ID that is acquired by the acquiring unit 132A and the fingerprint ID that is acquired by the ID issuing server 50 to the associating device 10.

Furthermore, in the example illustrated in FIG. 5, only the app control unit 130A and the app information storing unit 120A that are associated with the app A11 are illustrated; however, the terminal device 100 includes not only the app A11 but also an app control unit and an app information storing unit that are associated with each of the apps installed in the terminal device 100. For example, the terminal device 100 includes an app control unit and an app information storing unit. Furthermore, the processes, such as the association process performed by the app control unit 130A described above, may also be implemented by, for example, JavaScript (registered trademark).

The Browser Control Unit 130B

First, the browser control unit 130B will be described. The browser control unit 130B is a control unit that is associated with the browser B11 and performs the process, such as the association process performed by the browser B11, and various kinds of processes of the browser B11. In the example illustrated in FIG. 5, it is assumed that the browser control unit 130B and the browser information storing unit 120B are associated with the browser B11 and it is assumed that, for the other areas in the storing unit 120, an access is possible only in the area that is connected by a connecting cable. Thus, in the embodiment, the browser control unit 130B is not able to access the terminal ID storing unit 121, and thus is not able to acquire the terminal ID by the browser control unit 130B.

The browser control unit 130B includes, as particularly and closely related to the present invention, an accepting unit 131B, an acquiring unit 132B, an extracting unit 133B, and a sending unit 134B and implements or executes the function and the operation of the association process that will be described below. Furthermore, the internal configuration of the browser control unit 130B is not limited to the configuration illustrated in FIG. 5 but may also be another configuration as long as the configuration in which the association process, which will be described later, is performed is used. Furthermore, the internal configuration of the browser control unit 130B is not limited to the configuration illustrated in FIG. 5 but includes another configuration that is used to implement various kinds of processes performed by the browser B11.

The accepting unit 131B accepts an instruction and information related to a browser. For example, the accepting unit 131B accepts various kinds of operations from a user via an input unit. Furthermore, the accepting unit 131B accepts the information related to an update of an application or the like via the communication unit 110.

If the acquiring unit 132B sends the discrimination information to the ID issuing server 50, the acquiring unit 132B acquires the discrimination information from the discrimination information storing unit 122.

The extracting unit 133B extracts the cookie information from the cookie information storing unit 121B. Furthermore, as illustrated in FIG. 5, the extracting unit 133B accesses the cookie information storing unit 121B and extracts the cookie information that is associated with a predetermined server device.

The sending unit 134B sends the discrimination information that has been acquired by the acquiring unit 132B to the ID issuing server 50. Furthermore, the sending unit 134B sends the cookie information that has been extracted by the extracting unit 133B and the fingerprint ID that has been acquired from the ID issuing server 50 to the associating device 10.

Furthermore, in the example illustrated in FIG. 5, only the browser control unit 130B and the browser information storing unit 120B that are associated with the browser B11 are illustrated; however, the terminal device 100 includes not only the browser B11 but also the browser control unit and the browser information storing unit that are associated with each of the browsers installed in the terminal device 100. Furthermore, the processes, such as the association process performed by the browser control unit 130B described above may also implemented by, for example, JavaScript (registered trademark) or the like.

4. ID Issuing Server

In the following, the ID issuing server 50 will be described. The ID issuing server 50 receives the discrimination information from the terminal device 100. Furthermore, the ID issuing server 50 creates the fingerprint ID that is the feature information on the basis of the discrimination information acquired from the terminal device 100. Furthermore, the ID issuing server 50 sends the created fingerprint ID to the terminal device 100. For example, the ID issuing server 50 may also create, as a fingerprint ID, a unique ID that is associated with each of the discrimination information; associate the created fingerprint ID with the discrimination information; and manage the associated combination. Furthermore, for example, if the ID issuing server 50 acquires the discrimination information, the ID issuing server 50 may also use, as a fingerprint ID, a hash value that is created by converting the discrimination information that includes therein the information that is allocated to the terminal device 100 and that varies in accordance with the time elapsed by using a predetermined hash function.

5. Flow of the Association Process

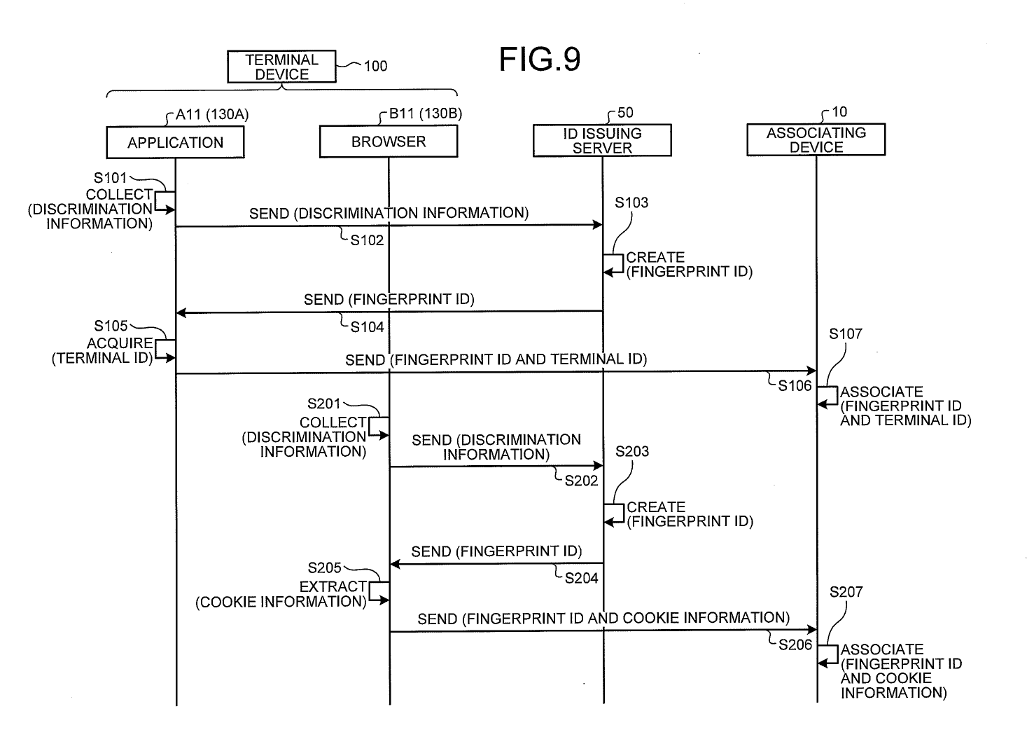

In the following, the flow of the association process performed by the association system 1 according to the embodiment will be described with reference to FIG. 9. FIG. 9 is a sequence diagram illustrating the flow of an association process according to the embodiment.

Specifically, FIG. 9 is a sequence diagram illustrating the flow of the association process that is performed when the terminal device 100 sends both the terminal ID and the fingerprint ID that are acquired by the app and the terminal device 100 sends both the cookie information in the browser and the fingerprint ID.

As illustrated in FIG. 9, the app A11 in the terminal device 100 collects the discrimination information that includes the information that is allocated to the terminal device 100 and that is related to the IP address that varies in accordance with the time elapsed (Step S101). Then, the app A11 sends the discrimination information collected at Step S101 to the ID issuing server 50 (Step S102).

The ID issuing server 50 that has received the discrimination information creates a fingerprint ID on the basis of the received discrimination information (Step S103). After having created the fingerprint ID, the ID issuing server 50 sends the created fingerprint ID to the terminal device 100 (Step S104).

After having acquired the fingerprint ID, the app A11 acquires the terminal ID from the terminal ID storing unit 121 in the terminal device 100 (Step S105). Furthermore, the app A11 may also receive the terminal ID before the app A11 acquires the fingerprint ID. Then, the app A11 sends the fingerprint ID acquired from the ID issuing server 50 to the associating device 10 together with the terminal ID that was acquired at Step S15 (Step S106).

The associating device 10 that has received both the terminal ID and the fingerprint ID from the terminal device 100 associates the terminal ID with the fingerprint ID (Step S107).

Subsequently, as illustrated in FIG. 9, the browser B11 in the terminal device 100 collects the discrimination information that includes therein the information that is allocated to the terminal device 100 and that is related to the IP address that varies in accordance with the time elapsed (Step S201). Then, the browser B11 sends the discrimination information collected at Step S201 to the ID issuing server 50 (Step S202).

The ID issuing server 50 that has received the discrimination information creates a fingerprint ID on the basis of the received discrimination information (Step S203). After having created the fingerprint ID, the ID issuing server 50 sends the Created fingerprint ID to the terminal device 100 (Step S204).

After having stored the fingerprint ID, the browser B11 extracts the cookie information that is related to the server associated with a predetermined domain name from the cookie C11 (Step S205). Then, the browser B11 sends the fingerprint ID acquired from the ID issuing server 50 to the associating device 10 together with the cookie information that is extracted at Step S205 (Step S206).

The associating device 10 that has received the cookie information and the fingerprint ID from the terminal device 100 associates the cookie information with the fingerprint ID (Step S207).

6. First Modification

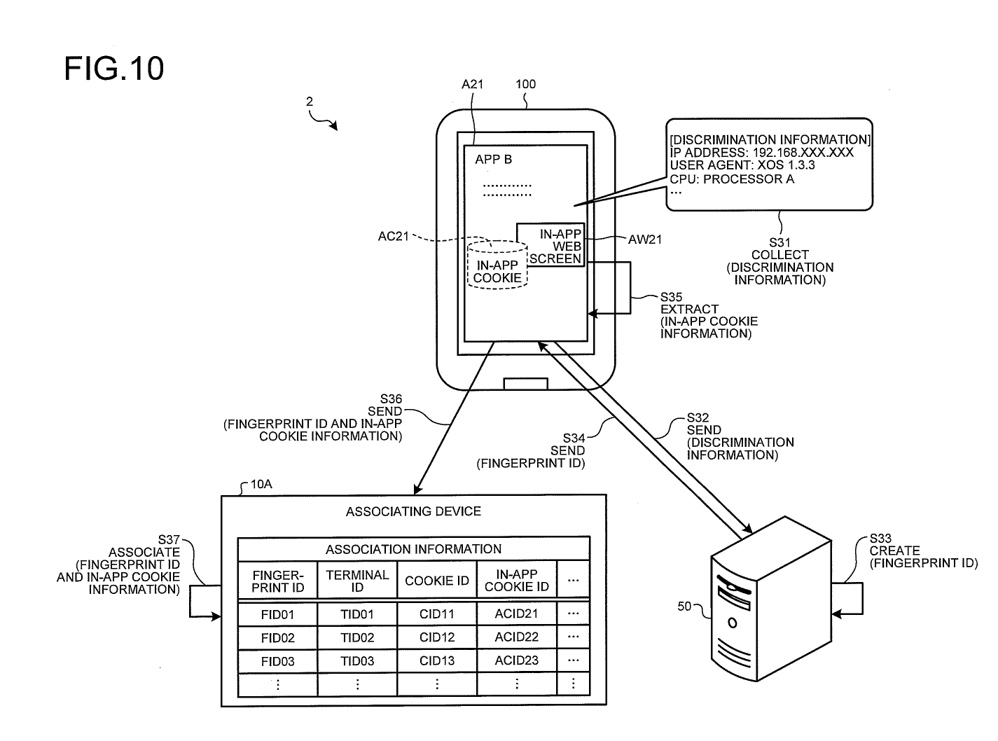

The association system 1 according to the embodiment described above may also be performed with various kinds of embodiments other than the embodiment described above. For example, the association system 2 according to a first modification also performs the association process on the cookie information in an in-app browser that is the browser included in the app. This point will be described with reference to FIG. 10. Furthermore, same reference signs are assigned to the same components as that described in the embodiment and descriptions thereof will be omitted.

FIG. 10 is a schematic diagram illustrating an example of an association process according to a modification. Specifically, FIG. 10 is a schematic diagram illustrating an example of the association process performed when the terminal device 100 sends in-app browser cookie information and a fingerprint ID. Furthermore, an associating device 10A illustrated in FIG. 10 has the same configuration as that of the associating device 10 except that the associating device 10A associates an in-app cookie ID with the fingerprint ID as the association information and stores the associated in-app cookie ID.

In the terminal device 100 illustrated in FIG. 10, an app B (hereinafter, referred to as an “app A21”) is started up and the app A21 is displayed on the terminal device 100. An in-app browser is included in the app A21 and, an in-app Web screen AW21 is displayed on the terminal device 100 illustrated in FIG. 10 by using the function of the in-app browser. In the storing unit 120, in the app information storing unit associated with the app A21, a Cookie in the app in the in-app browser (hereinafter, referred to as an “in-app cookie”) AC21 is stored.

As illustrated in FIG. 10, the app A21 in the terminal device 100 collects the discrimination information at a predetermined timing (Step S31). For example, the app A21 may also collect the discrimination information at the predetermined intervals (for example, the intervals of 10 minutes) at a timing at which the app A21 is started up or in a time period for which the app A21 is being started up. Furthermore, if the in-app Web screen AW 21 is displayed, the app A21 may collect the discrimination information. In the example illustrated in FIG. 10, the app A21 collects, as the discrimination information, the information that is related to the IP address that is allocated to the terminal device 100 at the time of collection at Step S31, the information that is related to the user agent in the terminal device 100, the information that is related to the CPU of the terminal device 100. Specifically, the app A21 collects, information as the discrimination information, the IP address “192.168.XXX.XXX”, the user agent “XOS 1.3.3”, the CPU “processor A”, and the like.

Then, the app A21 sends the discrimination information that is collected at Step S31 to the ID issuing server 50 (Step S32). For example, if the app A21 completes the collection of the discrimination information at Step S31, the app A21 immediately collects the discrimination information to the ID issuing server 50.

The ID issuing server 50 that has received the discrimination information creates a fingerprint ID on the basis of the received discrimination information (Step S33). After having created the fingerprint ID, the ID issuing server 50 sends the created fingerprint ID to the terminal device 100 (Step S34).

After having acquired the fingerprint ID, the app A21 extracts, from an in-app cookie AC21, the in-app cookie information that is related to the server that is associated with a predetermined domain name (Step S35). For example, the app A21 may also extracts, from the in-app cookie AC21, the cookie information that is related to the server that is associated with the domain name of the in-app Web screen AW 21 that is displayed when the cookie information is extracted at Step S35. Furthermore, the app A21 may also extract the cookie information before the app A21 receives the fingerprint ID. Then, the app A21 sends the fingerprint ID acquired from the ID issuing server 50 to the associating device 10A together with the cookie information that is extracted at Step S35 (Step S36).

The associating device 10A that has received the in-app cookie information and the fingerprint ID from the terminal device 100 associates the in-app cookie information with the fingerprint ID (Step S37). Consequently, the associating device 10A performs the association between the in-app cookie information and the fingerprint ID. Furthermore, if the received fingerprint ID has already been associated with the terminal ID and is registered, the associating device 10A associates the received in-app cookie information with the registered fingerprint ID. Consequently, the associating device 10A can perform the association among the in-app cookie information, the cookie information, and the terminal ID.

Furthermore, if the app A21 includes an SDK that can acquire the terminal ID from the terminal ID storing unit 121 in the terminal device 100, when the app A21 sends, at Step S36, the fingerprint ID acquired from the ID issuing server 50 to the associating device 10A together with the cookie information, the app A21 may also send the terminal ID to the associating device 10A.

7. Second Modification

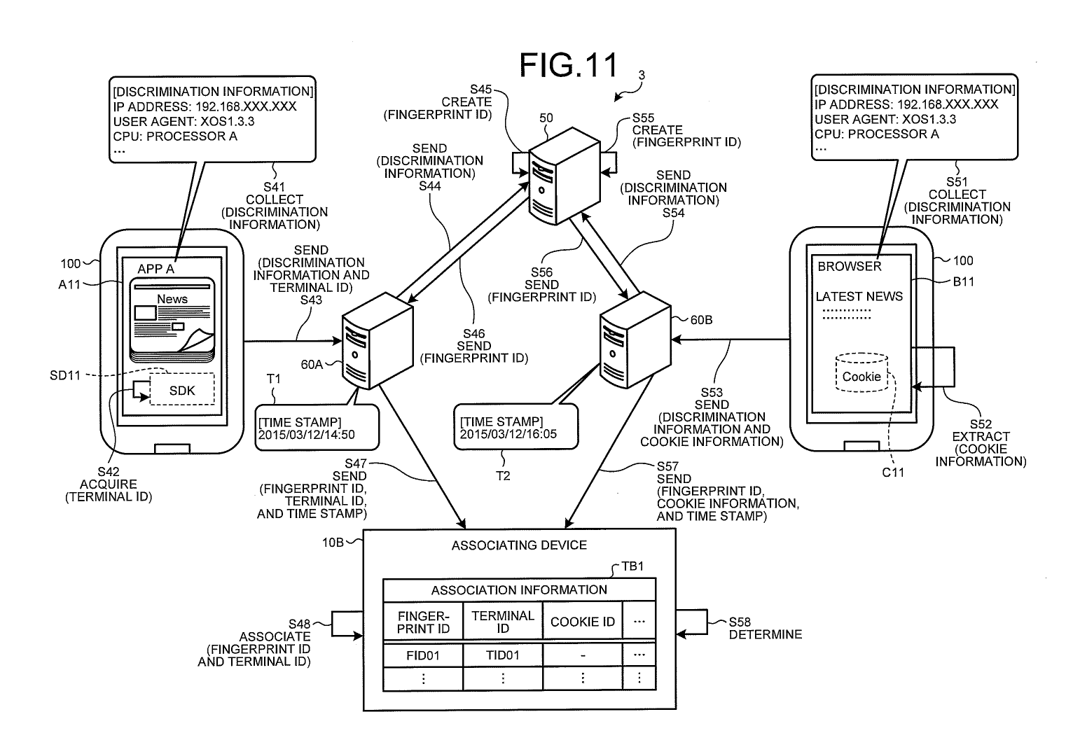

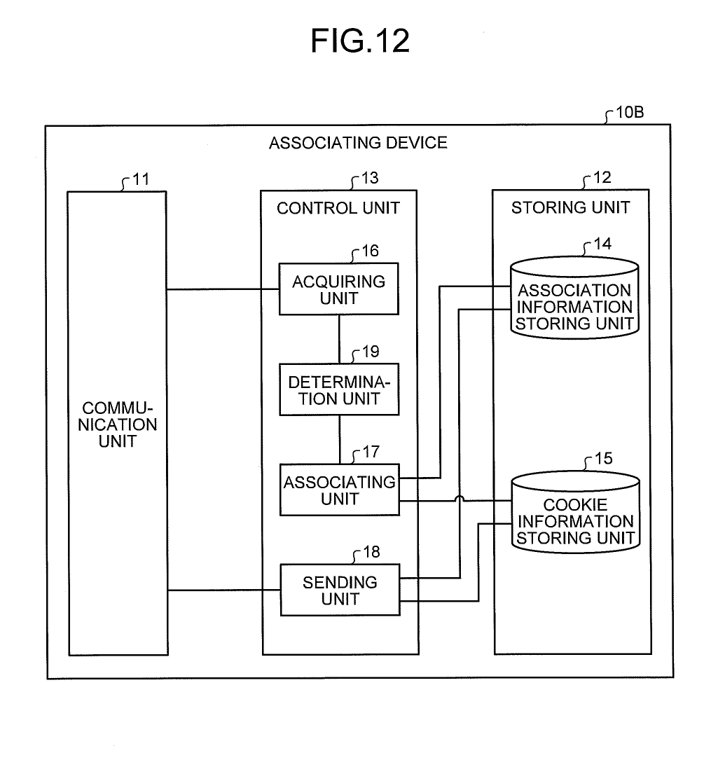

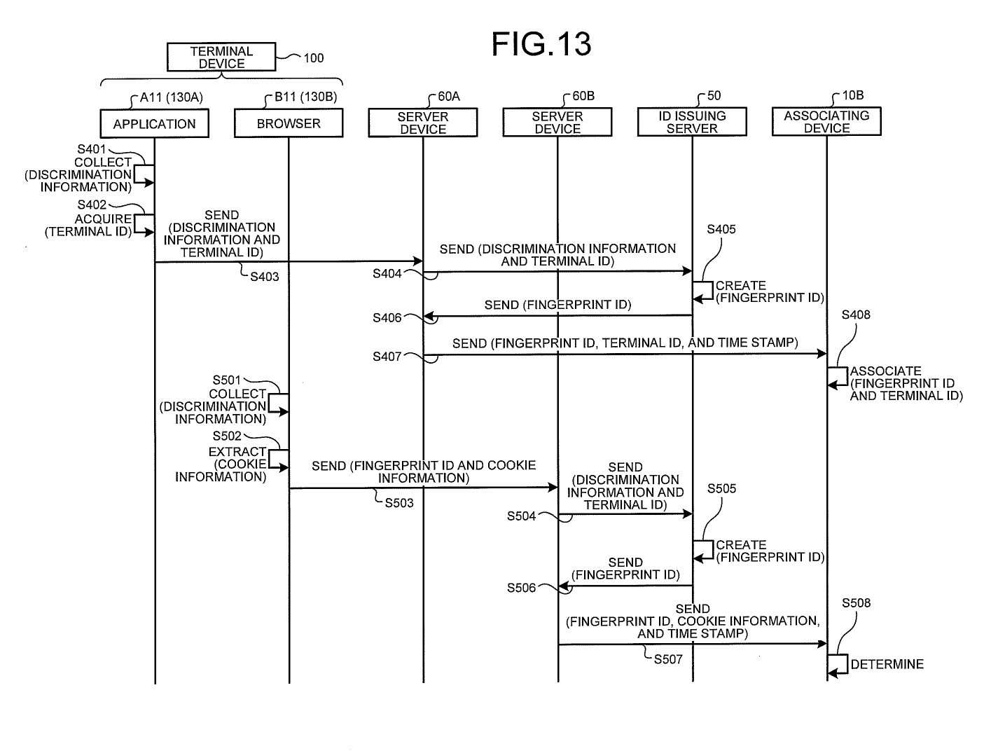

The association system 2 according to the embodiment described above may also be performed with various kinds of embodiments other than the embodiment described above. For example, an association system 3 according to the modification 2 determines whether the association needs to be performed in accordance with the time at which the information is acquired. This point will be described with reference to FIGS. 11 to 13. FIG. 11 is a schematic diagram illustrating an example of an association process according to a second modification. FIG. 12 is a schematic diagram illustrating a configuration example of a server device according to the second modification. FIG. 13 is a sequence diagram illustrating the flow of an association process according to the second modification. Furthermore, same reference signs are assigned to the same components as that described in the embodiment and descriptions thereof will be omitted.

7-1. Association Process

First, a description will be given of the association process performed when determining whether the association needs to be performed in accordance with the time at which the information is acquired. In the terminal device 100 illustrated on the left side in FIG. 11, the app A11 is started up and the app A11 is displayed on the terminal device 100.

As illustrated in FIG. 11, the app A11 in the terminal device 100 collects the discrimination information at a predetermined timing (Step S41). For example, the app A11 may also collect the discrimination information at the predetermined intervals (for example, at the intervals of 10 minutes) at the timing in which the app A11 is started up or in the time period for which the app A11 is being started up. In the example illustrated in FIG. 11, the app A11 collects, at the time of collection at Step S41 as the discrimination information, the information that is related to the IP address allocated to the terminal device 100, the information that is related to the user agent of the terminal device 100, and the information that is related to the CPU of the terminal device 100. Specifically, the app A11 collects, as the discrimination information, the information, such as the IP address “192.168.XXX.XXX”, the user agent “XOS 1.3.3”, the CPU “processor A”, and the like.

Then, the app A11 acquires the terminal ID from the terminal ID storing unit 121 in the terminal device 100 (Step S42). Furthermore, the app A11 may also acquire the terminal ID before the app A11 acquires the discrimination information at Step S41. Then, the app A11 sends the acquired terminal ID and the discrimination information that is acquired at Step S41 to a predetermined server device 60A (Step S43).

The server device 60A that has received the discrimination information and the terminal ID from the terminal device 100 sends the received discrimination information to the ID issuing server 50 (Step S44).

The ID issuing server 50 that has received the discrimination information creates a fingerprint ID on the basis of the received discrimination information (Step S45). After having created the fingerprint ID, the ID issuing server 50 sends the created fingerprint ID to the server device 60A (Step S46).

After having acquired the fingerprint ID, the server device 60A sends, to an associating device 10B, the terminal ID that is received at Step S43, the fingerprint ID that is received at Step S46, and a time stamp T1 (in FIG. 11, at 14:50 on 2015/3/12) obtained when the discrimination information and the terminal ID are received from the terminal device 100 (Step S47). In the example illustrated in FIG. 11, the server device 60A sends the fingerprint ID “FID01”, the terminal ID “TID01”, and the time stamp T1 “2015/03/12/14:50” to the associating device 10B.

If the interval between the time that is indicated by the time stamp T1 and the time at which the same fingerprint ID was acquired in the past satisfies a predetermined condition, the associating device 10B that has received the terminal ID, the fingerprint ID, and the time stamp T1 from the server device 60A associates the terminal ID with the fingerprint ID (Step S48). In the example illustrated in FIG. 11, because the fingerprint ID acquired from the server device 60A at Step S47 has not been registered, the associating device 10B registers the fingerprint ID by associating both the fingerprint ID “FID01” and the terminal ID “TID01” with the association information TB1.

In the terminal device 100 illustrated on the right side in FIG. 11, the browser has been started up and the browser B11 is displayed on the terminal device 100. Furthermore, the terminal device 100 illustrated on the right side in FIG. 11 performs the process at Step S51 and the subsequent processes after a predetermined time has elapsed since the process at Step S48 was performed.

As illustrated in FIG. 11, the browser B11 in the terminal device 100 collects the discrimination information at a predetermined timing (Step S51). In the example illustrated in FIG. 11, the browser B11 collects, as the discrimination information at the time of collection performed at Step S51, the information that is related to the IP address allocated to the terminal device 100, the information that is related to the user agent of the terminal device 100, and the information that is related to the CPU of the terminal device 100. Specifically, the browser B11 collects, as the discrimination information, the information, such as the IP address “192.168.XXX.XXX”, the user agent “XOS 1.3.3”, the CPU “processor A”, and the like.

Then, the browser B11 extracts, from the cookie C11, the cookie information that is related to the server that is associated with the predetermined domain name (Step S52). For example, the browser B11 may also extract, from the cookie C11, the cookie information related to a server device 60B that sends the information at Step S53. Furthermore, the browser B11 may also extract the cookie information before the discrimination information is collected at Step S51. Thereafter, the browser B11 sends the discrimination information collected at Step S51 to the predetermined server device 60B together with the extracted cookie information (Step S53).

The server device 60B that has received both the discrimination information and the terminal ID from the terminal device 100 sends the received discrimination information to the ID issuing server 50 (Step S54).

The ID issuing server 50 that has received the discrimination information creates a fingerprint ID on the basis of the received discrimination information (Step S55). After having created the fingerprint ID, the ID issuing server 50 sends the created fingerprint ID to the server device 60B (Step S56).

After having acquired the fingerprint ID, the server device 60B sends, to the associating device 10B, the cookie information received at Step S53, the fingerprint ID received at Step S56, and the time stamp T2 (in FIG. 11, at 16:05 on 2015/03/12) at which the discrimination information and the cookie information are received from the terminal device 100 (Step S57). In the example illustrated in FIG. 11, the server device 60B sends, to the associating device 10B, the fingerprint ID “FID01”, the cookie information received at Step S53, and the time stamp T2 “2015/03/12/16:05”.

Here, in the example illustrated in FIG. 11, the fingerprint ID received at Step S47 matches the fingerprint ID received at Step S57. Thus, the associating device 10B determines whether the time indicated by the time stamp T2 satisfies the predetermined condition (Step S58). For example, the associating device 10B determines the interval between the time at which the fingerprint ID is acquired at Step S57 and the time at which the fingerprint ID was acquired in the past (Step S47) satisfies the predetermined condition. Specifically, the associating device 10B compares the time stamp T1 received at Step S47 with the time stamp T2 received at Step S57. Furthermore, in the example illustrated in FIG. 11, it is assumed that the predetermined condition is within one hour after the same fingerprint ID was received last time. In the example illustrated in FIG. 11, the interval between the time point (14:50) at which the fingerprint ID is received at Step S47 and the time point (16:05) at which the fingerprint ID is received at Step S58 exceeds one hour. Consequently, the associating device 10B ends the process without associating the cookie information acquired at Step S57 with the fingerprint ID “FID01” that is registered in the TB1. Furthermore, the associating device 10B may also release the association between the fingerprint ID “FID01” and the terminal ID “TID01” that are registered in the TB1.

Consequently, the associating device 10B can suppress the state in which the information acquired from the terminal device 100 is associated with another mobile terminal. Furthermore, the predetermined condition used here is within one hour after the same fingerprint ID was received last time; however, this condition is only an example and various kinds of conditions are appropriately selected in accordance with purposes. Furthermore, the flow illustrated in FIG. 11 is an example and processes at Steps S41 to S48 may also be performed after the processes at Steps S51 to S58. In this case, determination whether the association is needed is performed at Step S48.

7-2. Configuration of the Server Device

In the following, the configuration of the associating device 10B according to the second modification will be described with reference to FIG. 12. FIG. 12 is a schematic diagram illustrating a configuration example of a server device according to the second modification. As illustrated in FIG. 12, the associating device 10B differs from the associating device 10 in that a determination unit 19 is included in the control unit 13.

The determination unit 19 determines whether the terminal ID and the cookie information acquired by the acquiring unit 16 are associated with the fingerprint ID. For example, if the fingerprint ID that is acquired by the acquiring unit 16 together with the terminal ID and the cookie information is the fingerprint ID that has already been registered, the determination unit 19 determines whether the interval between the time that is indicated by the time stamp acquired by the acquiring unit 16 together with the terminal ID and the cookie information and the time at which the same fingerprint ID was acquired in the past satisfies the predetermined condition. For example, if the interval between the time that is indicated by the time stamp obtained when the terminal ID and the cookie information are received and the time of the time stamp obtained when the same fingerprint ID was received in that past is within one hour, the determination unit 19 may also determine that the interval satisfies the predetermined condition.

If the interval between the time at which the acquiring unit 16 acquires the fingerprint ID and the time at which the same fingerprint ID is acquired in the past satisfies the predetermined condition, the associating unit 17 associates the terminal ID or the cookie information acquired by the acquiring unit 16 with the fingerprint ID.

For example, if the determination unit 19 determines that the interval between the time of the time stamp obtained when the terminal ID or the cookie information is received and the time of the time stamp obtained when the same fingerprint ID was received last time is within one hour and determines that the interval satisfies the predetermined condition, the associating unit 17 may also associate the fingerprint ID with the terminal ID or the cookie information.

If the interval between the time at which the fingerprint ID is acquired by the acquiring unit 16 and the time at which the fingerprint ID was acquired in the past does not satisfy the predetermined condition, the associating unit 17 releases the association of the terminal ID or the cookie information acquired by the acquiring unit 16 with respect to the fingerprint ID.

For example, because the interval between the time of the time stamp obtained when the terminal ID or the cookie information is received and the time of the time stamp obtained when the same fingerprint ID was received last time exceeds one hour, if the determination unit 19 determines that the interval does not satisfy the predetermined condition, the associating unit 17 may also release the association of the terminal ID or the cookie information with respect to the fingerprint ID. Furthermore, for example, if the determination unit 19 determines that the fingerprint ID acquired by the acquiring unit 16 together with the terminal ID is the fingerprint ID that has already been registered and determines that the acquired terminal ID is different from the terminal ID associated with the fingerprint ID, the associating unit 17 may also release the association between the fingerprint ID and the terminal ID.

7-3. Flow of the Association Process

In the following, the flow of the association process performed by an association system 3 according to the second modification will be described with reference to FIG. 13. FIG. 13 is a sequence diagram illustrating the flow of an association process according to the second modification. Specifically, FIG. 13 is a sequence diagram illustrating the flow of the association process performed when it is determined whether terminal ID and the cookie information acquired by the associating device 10B need to be associated. Furthermore, it is assumed that, at the time of start of the association process illustrated in FIG. 13, the fingerprint ID is not registered in the association information in the associating device 10B.

As illustrated in FIG. 13, the app A11 in the terminal device 100 collects the discrimination information including the information that is allocated to the terminal device 100 and that is related to the IP address that varies in accordance with the time elapsed (Step S401). Then, the app A11 acquires the terminal ID from the terminal ID storing unit 121 in the terminal device 100 (Step S402). Furthermore, the app A11 may also acquire the terminal ID before the app A11 collects the discrimination information at Step S401. Then, the app A11 sends the discrimination information collected at Step S401 to the predetermined server device 60A together with the acquired terminal ID (Step S403).

The server device 60A that has received both the discrimination information and the terminal ID from the terminal device 100 sends the received discrimination information to the ID issuing server 50 (Step S404).

The ID issuing server 50 that has received the discrimination information creates a fingerprint ID on the basis of the received discrimination information (Step S405). After having created the fingerprint ID, the ID issuing server 50 sends the created fingerprint ID to the server device 60A (Step S406).

After having acquired the fingerprint ID, the server device 60A sends, to the associating device 10B, the terminal ID received at Step S403, the fingerprint ID received at Step S406, and the time stamp obtained when the discrimination information and the terminal ID are received from the terminal device 100 (Step S407). For example, in FIG. 11, the server device 60A sends the fingerprint ID “FID01”, the terminal ID “TID01”, and the time stamp T1 “2015/03/12/14:50” to the associating device 10B.

If the time indicated by the time stamp T1 satisfies the predetermined condition, the associating device 10B that has received the terminal ID, the fingerprint ID, and the time stamp T1 from the server device 60A associates the terminal ID with the fingerprint ID (Step S408). In the example illustrated in FIG. 13, because the fingerprint ID is not registered in the association information in the associating device 10B and the fingerprint ID that is the same fingerprint ID as that received at Step S408 is not registered, the associating device 10B associates the fingerprint ID with the terminal ID acquired at Step S408 and then registers the acquired IDs.

Then, the browser B11 in the terminal device 100 collects the discrimination information that includes therein the information that is allocated to the terminal device 100 and that is related to the IP address that varies in accordance with the time elapsed (Step S501). Then, the browser B11 extracts, from the cookie C11, the cookie information related to the server associated with the predetermined domain name (Step S502). Furthermore, the browser B11 may also extract the cookie information before the browser B11 collects the discrimination information at Step S501. Thereafter, the browser B11 sends the discrimination information collected at Step S501 to the predetermined server device 60B together with the extracted cookie information (Step S503).

The server device 60B that has received the discrimination information and the terminal ID from the terminal device 100 sends the received discrimination information to the ID issuing server 50 (Step S504).

The ID issuing server 50 that has received the discrimination information creates a fingerprint ID on the basis of the received discrimination information (Step S505). After having created the fingerprint ID, the ID issuing server 50 sends the created fingerprint ID to the server device 60B (Step S506).

After having acquired the fingerprint ID, the server device 60B sends, to the associating device 10B, the cookie information received at Step S503, the fingerprint ID received at Step S506, and the time stamp that is obtained when both the discrimination information and the cookie information are received from the terminal device 100 (Step S507). For example, in FIG. 11, the server device 60B sends the fingerprint ID “FID01”, the terminal ID “TID01”, and the time stamp T2 “2015/03/12/16:05” to the associating device 10B.

At this point, if the fingerprint ID that is associated at Step S408 and the fingerprint ID that is acquired at Step S507 match, the associating device 10B determines whether the time indicated by the time stamp that is acquired at Step S507 together with the fingerprint ID satisfies the predetermined condition (Step S508). If the associating device 10B determines that the predetermined condition is satisfied at Step S508, the associating device 10B associates the cookie information that is acquired at Step S507 with the fingerprint ID that is associated at Step S408. Furthermore, if the associating device 10B determines that the predetermined condition is not satisfied at Step S508, the associating device 10B ends the process without performing the association. Furthermore, the second modification 2 indicates an example in which the associating device 10B acquires the time stamp together with the fingerprint ID by using the server devices 60A and 60B; however, the associating device 10B may also acquire the time stamp together with the fingerprint ID from the terminal device 100.

8. Effects

As described above, each of the associating devices 10, 10A, and 10B that are information processing apparatuses according to the embodiment and the first and the second modifications includes the acquiring unit 16 and the associating unit 17. The acquiring unit 16 acquires, from an application 11A (130A), the terminal information (in the embodiment, the terminal ID. The same also applies to the description below.) that is used to identify the terminal device 100 and the feature information (in the embodiment, the fingerprint ID. The same also applies to the description below.) that is created on the basis of the information that is allocated to the terminal device 100 and that varies in accordance with the time elapsed and acquires, from a browser 11B (130B), the cookie information and the feature information. The associating unit 17 associates the terminal information acquired by the acquiring unit 16 and the cookie information acquired by the acquiring unit 16 with the feature information acquired by the acquiring unit 16.

Consequently, the associating devices 10, 10A, and 10B can appropriately associate the information collected from the same terminal device. Furthermore, the associating devices 10, 10A, and 10B can perform the association between the terminal ID and the cookie information. For example, the associating devices 10, 10A, and 10B provide the association information to an external information processing apparatus, for example, an advertisement distribution device included in the association systems 1, 2, and 3, respectively. Consequently, the association systems 1, 2, and 3 can perform an appropriate advertisement distribution with respect to a user. Accordingly, the association systems 1, 2, and 3 can increase the advertising effectiveness. Furthermore, the associating devices 10, 10A, and 10B may also be advertisement distribution devices that perform an advertisement distribution on the basis of the association information. Consequently, the association systems 1, 2, and 3 can perform an appropriate advertisement distribution with respect to a user. Accordingly, the association systems 1, 2, and 3 can increase the advertising effectiveness.

Furthermore, in the associating device 10B according to the second modification, if the interval between the time at which the feature information is acquired by the acquiring unit 16 and the time at which the feature information was acquired in the past satisfies the predetermined condition, the associating unit 17 associates the terminal information or the cookie information acquired by the acquiring unit 16 with the feature information.

Consequently, by performing the association on the basis of the time at which the feature information is acquired, the associating device 10B can suppress information in different terminal devices 100 from being associated. Thus, the associating device 10B can further appropriately associate pieces of information collected from the same terminal device 100.

Furthermore, in the associating device 10B according to the second modification, if the interval between the time at which the feature information is acquired by the acquiring unit 16 and the time at which the feature information was acquired in the past does not satisfy the predetermined condition, the associating unit 17 releases the association between the feature information and the terminal information or the cookie information.

Consequently, by releasing the association on the basis of the time at which the feature information is acquired, the associating device 10B can appropriately release the association even if information in different terminal devices 100 is associated. Accordingly, the associating device 10B can further appropriately associate the pieces of information collected from the same terminal device 100.

Furthermore, in the associating devices 10, 10A, and 10B according to the embodiment and the first and the second modifications, the acquiring unit 16 acquires, from the application A11, both the terminal information and the feature information, which is created on the basis of the information that related to the IP address that is allocated to the terminal device 100 and acquires, from the browser B11, the cookie information and the feature information.

Consequently, the associating devices 10, 10A, and 10B according to the embodiment and the modifications 1 and 2, respectively, perform the association between pieces of information by using the feature information on the basis of the IP address allocated to the terminal device 100, whereby the associating devices 10, 10A, and 10B can appropriately associate pieces of information collected from the same terminal device 100.

Furthermore, in the associating devices 10, 10A, and 10B according to the embodiment and the first and the second modifications, respectively, the feature information is created on the basis of, in addition to the IP address, the terminal information or the system information on the terminal device.

Consequently, the associating devices 10, 10A, and 10B according to the embodiment and the first and the second modifications, respectively, associate pieces of information by using the feature information that is created on the basis of, in addition to the IP address allocated to the terminal device 100, the terminal information and the system information on the terminal device 100, whereby the associating devices 10, 10A, and 10B can appropriately associate the pieces of information collected from the same terminal device 100.

Furthermore, in the associating device 10A according to the first modification, the acquiring unit 16 acquires the in-app cookie information, which is associated with the in-app browser that is the browser included in the application 11A (130A), and the feature information.

Consequently, the associating device 10A according to the first modification can appropriately associate pieces of information including the in-app cookie information collected from the same terminal device. Namely, the associating device 10A can perform the association of the terminal ID, the cookie information, and the in-app cookie information.

Furthermore, the terminal device 100 according to the embodiment and the first and the second modifications is the terminal device 100 that includes the application 11A (130A) and the browser 11B (130B). The application 11A (130A) includes the sending unit 133A that sends, to the information processing apparatus (the associating devices 10, 10A, and 10B), the terminal information, which is acquired by the application 11A (130A), and the feature information, which is created on the basis of the information that is allocated to the terminal device 100 and that varies in accordance with the time elapsed. The browser 11B (130B) includes the sending unit 134B that sends, to the information processing apparatus (the associating devices 10, 10A, and 10B), both the cookie information in the browser 11B (130B) and the feature information.

Consequently, the associating devices 10, 10A, and 10B that have acquired the information from the terminal device 100 can appropriately associate the pieces of information collected from the same terminal device 100. Furthermore, the associating devices 10, 10A, and 10B can perform the association between the terminal ID and the cookie information. For example, the associating devices 10, 10A, and 10B provide the association information to an external information processing apparatus, for example, an advertisement distribution device included in the association systems 1, 2, and 3, respectively. Consequently, the association systems 1, 2, and 3 can perform an appropriate advertisement distribution with respect to a user. Accordingly, the association systems 1, 2, and 3 can increase the advertising effectiveness. Furthermore, the associating devices 10, 10A, and 10B may also be an advertisement distribution device that performs the advertisement distribution on the basis of the association information. Consequently, the association systems 1, 2, and 3 can perform an appropriate advertisement distribution with respect to a user. Accordingly, the association systems 1, 2, and 3 can increase the advertising effectiveness.

9. Hardware Configuration

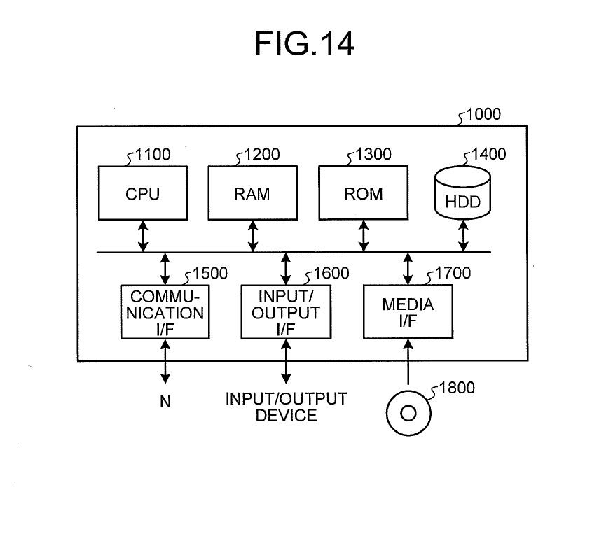

The associating devices 10, 10A, and 10B according to the embodiment and the first and the second modification are implemented by, for example, a computer 1000 having the configuration illustrated in FIG. 14. FIG. 14 is a block diagram illustrating an example of the hardware configuration of a computer that implements the function performed by an information processing apparatus (associating device). The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates on the basis of a program stored in the ROM 1300 or the HDD 1400 and controls each of the units. The ROM 1300 stores therein a boot program that is executed by the CPU 1100 when the computer 1000 is started up, a program that depends on the hardware of the computer 1000, or the like.

The HDD 1400 stores therein the program executed by the CPU 1100, data that is used by the program, or the like. The communication interface 1500 receives data from other devices via the network N, sends the data to the CPU 1100, and sends data created by the CPU 1100 to other devices.

The CPU 1100 controls, via the input/output interface 1600, an output device, such as a display or a printer, and an input device, such as a keyboard or a mouse. The CPU 1100 acquires data from the input device through the input/output interface 1600. Furthermore, the CPU 1100 outputs the created data to the output device through the input/output interface 1600.

The media interface 1700 reads a program or data stored in a recording medium 1800 and provides the program or the data to the CPU 1100 via the RAM 1200. The CPU 1100 loads the program on the RAM 1200 from the recording medium 1800 via the media interface 1700 and executes the loaded program. The recording medium 1800 is, for example, an optical recording medium, such as a digital versatile disc (DVD) or a phase change rewritable disk (PD), a magneto-optical recording medium, such as a magneto-optical disk (MO), a tape medium, a magnetic recording medium, or a semiconductor memory.

For example, when the computer 1000 functions as the associating device 10 according to the embodiment, the CPU 1100 of the computer 1000 executes the program loaded in the RAM 1200 to implement the functions of the control unit 130. The CPU 1100 in the computer 1000 reads the programs from the recording medium 1800 and executes the programs. Alternatively, the CPU 1100 may also acquire the programs from other devices via the network N.

In the above, embodiments of the present invention have been described; however, the embodiments are described only by way of an example. In addition to the embodiments in disclosure of invention, the present invention can be implemented in a mode in which various modifications and changes are made in accordance with the knowledge of those skilled in the art.

10. Others

Of the processes described in the embodiment, the whole or a part of the processes that are mentioned as being automatically performed can also be manually performed, or the whole or a part of the processes that are mentioned as being manually performed can also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

The components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

Furthermore, each of the embodiments described above can be appropriately used in combination as long as the processes do not conflict with each other.

Furthermore, the “components (sections, modules, units)” described above can be read as “means”, “circuits”, or the like. For example, the acquiring unit can be read as an acquiring means or an acquiring circuit.

According to an aspect of an embodiment, an advantage is provided in that information collected from the same terminal device can be appropriately associated.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an acquiring unit that acquires, from an application, terminal information, which is used to identify a terminal device, and feature information, which is created on the basis of information that is allocated to the terminal device and that varies in accordance with the time elapsed, and that acquires, from a browser, cookie information and the feature information; and
an associating unit that associates both the terminal information acquired by the acquiring unit and the cookie information acquired by the acquiring unit with the feature information acquired by the acquiring unit.

2. The information processing apparatus according to claim 1, wherein, when an interval between the time at which the feature information is acquired by the acquiring unit and the time at which the feature information was acquired in the past satisfies a predetermined condition, the associating unit associates the terminal information or the cookie information acquired by the acquiring unit with the feature information.

3. The information processing apparatus according to claim 1, wherein, when the interval between the time at which the feature information is acquired by the acquiring unit and the time at which the feature information was acquired in the past does not satisfy the predetermined condition, the associating unit releases the association between the feature information and the terminal information or the cookie information.

4. The information processing apparatus according to claim 1, wherein the acquiring unit acquires, from the application, the terminal information and the feature information that is created on the basis of information related to an IP address allocated to the terminal device and acquires, from the browser, the cookie information and the feature information.

5. The information processing apparatus according to claim 4, wherein the feature information is created on the basis of, in addition to the IP address, the terminal information or system information on the terminal device.

6. The information processing apparatus according to claim 1, wherein
the acquiring unit acquires in-app cookie information, which is associated with an in-app browser that is a browser included in the application, and the feature information, and
the associating unit associates the in-app cookie information acquired by the acquiring unit with the feature information acquired by the acquiring unit.

7. A terminal device comprising:
an application; and
a browser, wherein
the application includes
a sending unit that sends, to an information processing apparatus, terminal information, which is acquired by the application, and feature information, which is created on the basis of information that is allocated to the terminal device and that varies in accordance with the time elapsed, and
the browser includes
a sending unit that sends, to the information processing apparatus, both cookie information in the browser and the feature information.

8. An information processing method implemented by a computer, the information processing method comprising:
acquiring, from an application, terminal information, which is used to identify a terminal device, and feature information, which is created on the basis of information that is allocated to the terminal device and that varies in accordance with the time elapsed, and acquiring, from a browser, cookie information and the feature information; and
associating both the terminal information acquired at the acquiring and the cookie information acquired at the acquiring with the feature information acquired at the acquiring.

9. A non-transitory computer-readable recording medium having stored therein an information processing program that causes a computer to execute a process comprising:
acquiring, from an application, terminal information, which is used to identify a terminal device, and feature information, which is created on the basis of information that is allocated to the terminal device and that varies in accordance with the time elapsed, and acquiring, from a browser, cookie information and the feature information; and
associating both the terminal information acquired at the acquiring and the cookie information acquired at the acquiring with the feature information acquired at the acquiring.
